(19) United States
(12) Patent Application Publication
(10) Pub. No.: US 2016/0299222 A1
(43) Pub. Date: Oct. 13, 2016

(54) RADAR DEVICE AND DISTANCE AND SPEED MEASUREMENT METHOD

(71) Applicant: Mitsubishi Electric Corporation, Chiyoda-ku, Tokyo (JP)

(72) Inventors: Masahiro Watanabe, Chiyoda-ku (JP); Yoshitsugu Sawa, Chiyoda-ku (JP); Kenji Inomata, Chiyoda-ku (JP); Satoru Inoue, Chiyoda-ku (JP)

(73) Assignee: Mitsubishi Electric Corporation, Chiyoda-ku, Tokyo (JP)

(21) Appl. No.: 15/037,379

(22) PCT Filed: Sep. 30, 2014
(86) PCT No.: PCT/JP2014/076124

§ 371 Date: May 18, 2016

(30) Foreign Application Priority Data
Dec. 27, 2013 (JP) 2013-271871

(51) Int. Cl. G01S 13/58; G01S 13/93

(52) U.S. Cl. CPC G01S 13/582; G01S 13/931; G01S 2013/9375

(57) ABSTRACT

A radar device including an ADC that performs slide sampling on frequency difference signals outputted from a mixer, and classifies sampling data about the frequency difference signals according to range bins based on a distance resolution corresponding to a pulse width set by a controller, and a speed discrimination unit that separates the sampling data about each range bin after being classified by the ADC according to relative speeds of objects. A distance and speed measurement unit calculates the distance to and the relative speed of an object which has reflected a transmission pulse by using the sampling data after being separated according to relative speeds by the speed discrimination unit.

### FIELD OF THE INVENTION

The present invention relates to a radar device for and a distance and speed measurement method of detecting a preceding vehicle etc. on a road environment by using, for example, a radio wave having a relatively narrow occupied bandwidth.

### BACKGROUND OF THE INVENTION

In a radar device disclosed by the following nonpatent reference 1, a pulsed Doppler radar method of emitting pulses into space is used.

This radar device sets the pulse width and the transmission period of transmission pulses at the time of emitting pulses into space, while in order to provide a high distance resolution and a high speed resolution, the radar device sets a narrow pulse width and a short transmission period.

When narrowing the pulse width of transmission pulses and shortening the transmission period of transmission pulses in this way, it is necessary to ensure a wide occupied bandwidth as the occupied bandwidth of the radio wave.

### RELATED ART DOCUMENT

### Nonpatent Reference

Nonpatent reference 1: “Radar engineering revised edition” The Institute of Electronics, Information and Communication Engineers Publications Department, third chapter radar signal processing

### SUMMARY OF THE INVENTION

### Problems to be Solved by the Invention

Because the conventional radar device is configured as above, if a wide occupied bandwidth can be ensured as the occupied bandwidth of the radio wave, a narrow pulse width and a short transmission period can be set and therefore a high distance resolution and a high speed resolution can be provided. A problem is however that under an environment in which there are many users which are using the radio wave and it is therefore difficult to ensure a wide occupied bandwidth, a narrow pulse width and a short transmission period cannot be set and therefore a high distance resolution and a high speed resolution cannot be provided.

The present invention is made in order to solve the above-mentioned problems, and it is therefore an object of the present invention to provide a radar device and a distance and speed measurement method capable of calculating the distance to and the relative speed of an object, such as a preceding vehicle, with a high degree of accuracy also under an environment in which it is difficult to ensure a wide occupied bandwidth.

### Means for Solving the Problem

According to the present invention, there is provided a radar device including: a pulse setter to set a pulse width and a transmission period of transmission pulses; a pulse transmitter to generate transmission pulses each having the pulse width set by the pulse setter, and repeatedly emit the above-mentioned transmission pulses into space at intervals of the transmission period set by the pulse setter; a pulse receiver to receive, as reflected pulses, transmission pulses which are included in the transmission pulses emitted from the pulse transmitter and each of which is reflected by an object and then returns thereto, and output frequency difference signals respectively showing frequency differences between the reflected pulses and the transmission pulses emitted from the pulse transmitter; a sampler to sample the frequency difference signals outputted from the pulse receiver and classify sampling data about the frequency difference signals according to range bins based on a distance resolution corresponding to the pulse width set by the pulse setter; a signal separator to separate sampling data about each of the range bins after being classified by the sampler according to relative speeds of objects; and a distance and speed calculator to calculate the distance to and the relative speed of the object which has reflected the transmission pulse by using sampling data after being separated according to relative speeds by the signal separator.

### Advantages of the Invention

Because the radar device according to the present invention is configured in such a way that the radar device includes the sampler to sample the frequency difference signals outputted from the pulse receiver and classify the sampling data about the frequency difference signals according to the range bins based on the distance resolution corresponding to the pulse width set by the pulse setter, and the signal separator to separate the sampling data about each of the range bins after being classified by the sampler according to relative speeds of objects, and the distance and speed calculator calculates the distance to and the relative speed of an object which has reflected a transmission pulse by using the sampling data after being separated according to relative speeds by the signal separator, there is provided an advantage of being able to calculate the distance to and the relative speed of each object with a high degree of accuracy even under an environment in which it is difficult to ensure a wide occupied bandwidth.

### BRIEF DESCRIPTION OF THE FIGURES

FIG. 1 is a block diagram showing a radar device according to Embodiment 1 of the present invention;

FIG. 2 is a flow chart showing the details of processing (a distance and speed measurement method) of the radar device according to Embodiment 1 of the present invention;

FIG. 3 is an explanatory drawing showing a slide sampling process performed by an ADC 7;

FIG. 4 is an explanatory drawing showing a relation between the pulse width W and the transmission period P of transmission pulses and a distance resolution;

FIG. 5 is an explanatory drawing showing a state in which the radar device detects a preceding vehicle;

FIG. 6 is an explanatory drawing showing a state in that data Rx3 about a preceding vehicle is separated from combined data about a range bin R₄ in which a preceding vehicle, a tree and a road surface exist; and

FIG. 7 is an explanatory drawing showing a difference between the strength of a signal before a filtering process by a speed discrimination unit 10, and the strength of the signal after the filtering process.

### EMBODIMENTS OF THE INVENTION

Hereafter, in order to explain this invention in greater detail, the preferred embodiments of the present invention will be described with reference to the accompanying drawings. Embodiment 1.

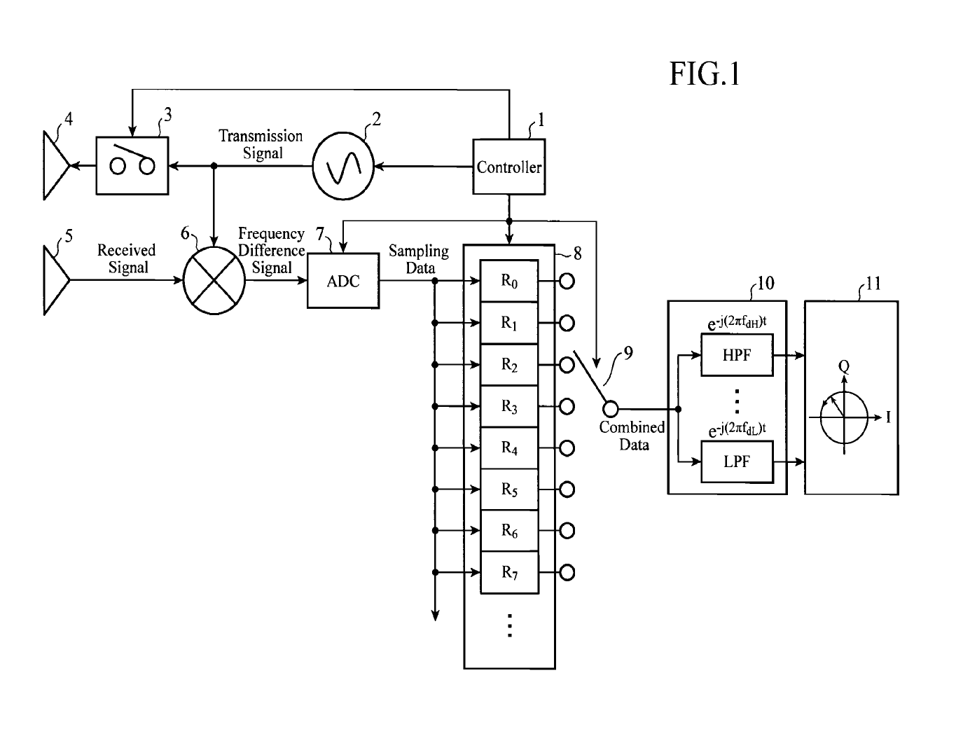

FIG. 1 is a block diagram showing a radar device according to Embodiment 1 of the present invention. The radar device of FIG. 1 detects an object existing in a range of relatively short distances.

In the example of FIG. 1, a controller 1 is comprised of a semiconductor integrated circuit equipped with a CPU, a one chip microcomputer, or the like, and performs a process of setting the pulse width W and the transmission period P of transmission pulses and also controlling the frequency of a radio wave oscillated by an oscillator 2. The controller 1 constructs a pulse setter.

The oscillator 2 oscillates a radio wave (referred to as a “transmission signal” from here on) having a frequency which is indicated by the controller 1.

A pulse modulator 3 performs pulse modulation on the transmission signal oscillated by the oscillator 2 to generate transmission pulses each having the pulse width W set by the controller 1, and repeatedly outputs the transmission pulses to a transmission antenna 4 at intervals of the transmission period P set by the controller 1.

The transmission antenna 4 emits the transmission pulses outputted from the pulse modulator 3 into space.

A pulse transmitter is comprised of the oscillator 2, the pulse modulator 3 and the transmission antenna 4.

The reception antenna 5 receives, as reflected pulses, transmission pulses which are included in the transmission pulses emitted from the transmission antenna 4 and each of which is reflected by an object (e.g., a preceding vehicle, a tree, or a road surface) and returns thereto, and outputs the reflected pulses to a mixer 6 as received signals.

The mixer 6 is a mixing circuit that multiplies the transmission signal oscillated by the oscillator 2 and each of the received signals outputted from the reception antenna 5 to output a frequency difference signal showing the frequency difference between the transmission signal and the received signal.

A pulse receiver is comprised of the reception antenna 5 and the mixer 6.

An ADC (Analog to Digital Converter) 7 which is an A/D converter performs slide sampling on the in-phase component and the quadrature-phase component of each frequency difference signal outputted from the mixer 6.

More specifically, the ADC 7 performs a slide sampling process of sampling each frequency difference signal outputted from the mixer 6 at intervals of a period a little longer than the transmission period P set by the controller 1 (a period longer than the transmission period P and shorter than the period which is the sum of the transmission period P and the pulse width W).

Further, the ADC 7 performs a process of classifying sampling data about the frequency difference signals according to range bins (R₀, R₁, R₂, . . . ) based to a distance resolution corresponding to the pulse width W set by the controller 1.

A distance counter 8 is provided with a memory corresponding to each of the range bins (R₀, R₁, R₂, . . . ), and performs a process of combining a plurality of sampling data belonging to each identical range bin by, every time when sampling data is outputted from the ADC 7, storing the sampling data in the memory corresponding to the corresponding range bin.

For example, when the range bin of sampling data outputted from the ADC 7 is R1, the sampling data is stored in the memory corresponding to the range bin R1, and the plurality of sampling data stored in the memory corresponding to the range bin R1 are combined.

A selection switch 9 is connected to a memory, among the memories respectively corresponding to the range bins (R₀, R₁, R₂, . . . ) of the distance counter 8, which is indicated by the controller 1, and outputs the combined data of the plurality of sampling data stored in that memory to a speed discrimination unit 10.

A sampler is comprised of the ADC 7, the distance counter 8 and the selection switch 9.

The speed discrimination unit 10 is provided with a plurality of filters having different frequency characteristics (an HPF (high pass filter) having a frequency characteristic of e^{-j(2πfdH)t}, an LPF (low pass filter) having a frequency characteristic of e^{-j(2πfdL)t}, and so on), and performs a process of separating the combined data outputted from the selection switch 9 according to relative speeds of objects by causing the combined data to pass through the plurality of filters. The speed discrimination unit 10 constructs a signal separator.

A distance and speed measurement unit 11 is comprised of a semiconductor integrated circuit equipped with a CPU, a one chip microcomputer, or the like, and performs a process of calculating the distance R to and the relative speed V of an object existing at each of the range bins (R₀, R₁, R₂, . . . ) (an object which has reflected a transmission pulse) by using the combined data after being separated according to relative speeds by the speed discrimination unit 10. The distance and speed measurement unit 11 constructs a distance and speed calculator.

In the example of FIG. 1, it is assumed that each of the following components: the controller 1, the oscillator 2, the pulse modulator 3, the transmission antenna 4, the reception antenna 5, the mixer 6, the ADC 7, the distance counter 8, the selection switch 9, the speed discrimination unit 10 and the distance and speed measurement unit 11 which are the components of the radar device consists of hardware for exclusive use. As an alternative, a part of the radar device can consist of a computer.

In the case in which a part of the radar device (e.g., the controller 1, the distance counter 8, the selection switch 9, the speed discrimination unit 10 and the distance and speed measurement unit 11) consists of a computer, a program in which the details of processes performed by the controller 1, the distance counter 8, the selection switch 9, the speed discrimination unit 10 and the distance and speed measurement unit 11 are described can be stored in a memory of the computer, and a CPU of the computer can be made to execute the program stored in that memory.

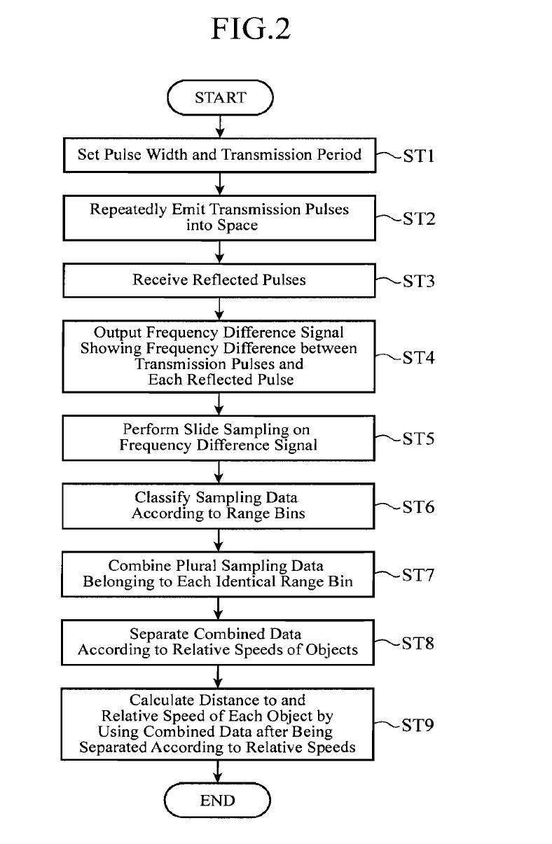

FIG. 2 is a flow chart showing the details of processing (a distance and speed measurement method) performed by the radar device according to Embodiment 1 of the present invention.

Next, operations will be explained.

The controller 1 commands the oscillator 2 to oscillate a radio wave having a narrow occupied bandwidth such as a bandwidth in, for example, a 24 GHz band.

The oscillator 2 oscillates a radio wave whose frequency is, for example, 24 GHz according to a command from the controller 1, and outputs the radio wave, as a transmission signal, to the pulse modulator 3 and the mixer 6.

The controller 1 also sets the pulse width W and the transmission period P of transmission pulses (step ST1).

Because it is necessary to ensure a wide occupied bandwidth as the occupied bandwidth of the radio wave when the pulse width W of transmission pulses is narrowed and the transmission period P of transmission pulses is shortened, a wide pulse width such as 50 ns is set and a long transmission period P such as 100 ns (= 1/10 MHz) is set, for example.

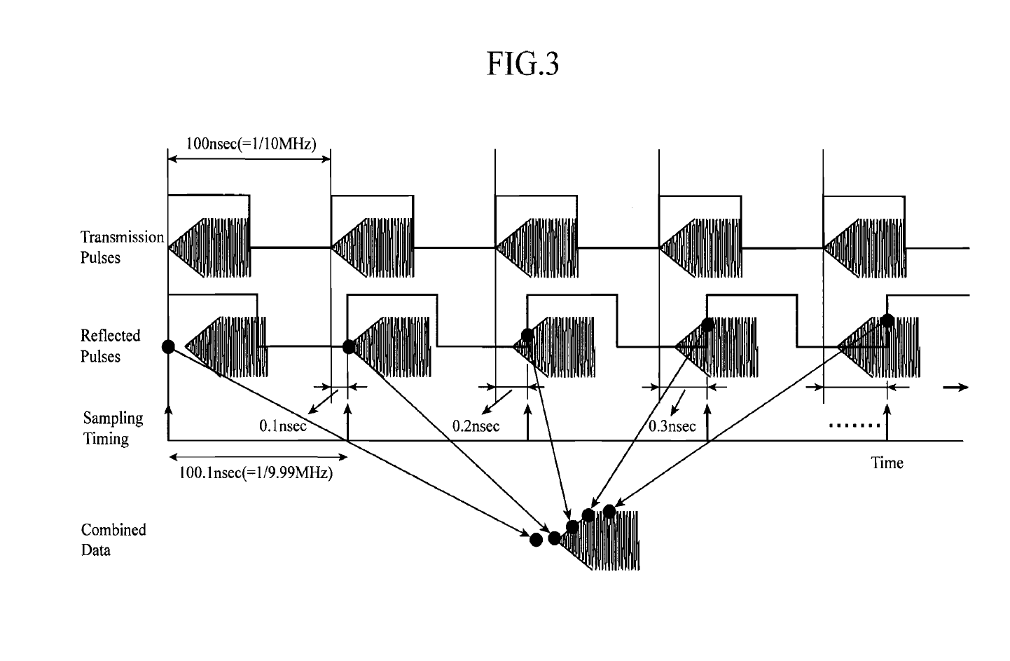

FIG. 3 is an explanatory drawing showing the slide sampling process performed by the ADC 7. In the example of FIG. 3, the transmission period P of transmission pulses is set to 100 ns (= 1/10 MHz).

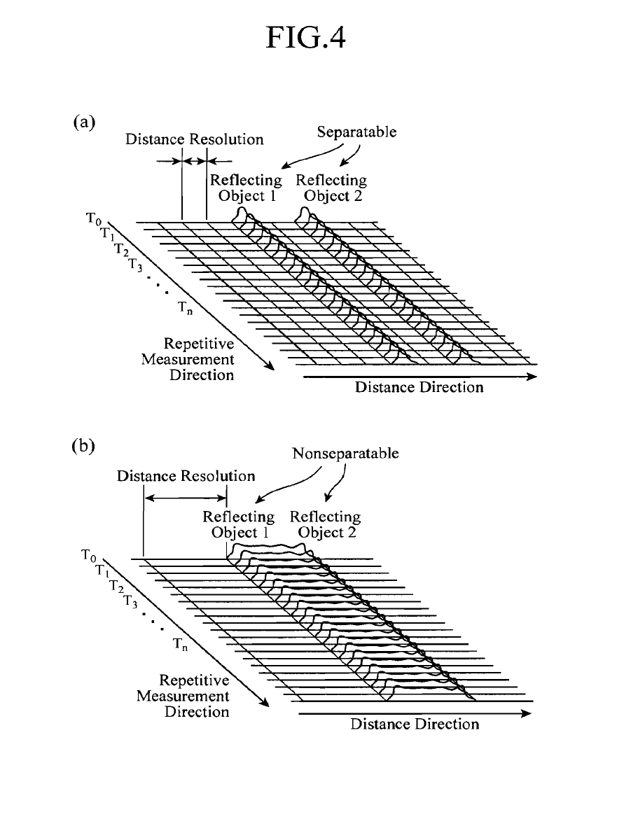

Although the distance resolution can be improved as shown in FIG. 4(a) by narrowing the pulse width W of transmission pulses and shortening the transmission period P of transmission pulses, it is necessary to ensure a wide occupied bandwidth as the occupied bandwidth of the radio wave, as mentioned above.

In contrast, although the occupied bandwidth of the radio wave can be narrowed by widening the pulse width W of transmission pulses and lengthening the transmission period P of transmission pulses, the distance resolution degrades, as shown in FIG. 4(b).

When receiving the transmission signal from the oscillator 2, the pulse modulator 3 performs pulse modulation on the transmission signal to generate transmission pulses each having the pulse width W set by the controller 1, and repeatedly outputs the transmission pulses to the transmission antenna 4 at intervals of the transmission period P set by the controller 1.

As a result, the transmission pulses each having the pulse width W are repeatedly emitted from the transmission antenna 4 into space at intervals of the transmission period P (step ST2).

The reception antenna 5 receives, as reflected pulses, transmission pulses which are included in the transmission pulses emitted from the transmission antenna 4 and each of which is reflected by an object (e.g., a preceding vehicle, a tree, a road surface, or the like) and then returns thereto, and outputs the reflected pulses to the mixer 6 as received signals (step ST3).

Each reflected pulse is received after a time proportional to the distance to an object has elapsed since a corresponding transmission pulse has been emitted from the transmission antenna 4, as shown in FIG. 3.

In the example of FIG. 3, five transmission pulses are emitted repeatedly and five reflected pulses are received.

When receiving a received signal from the reception antenna 5, the mixer 6 multiplies the transmission signal oscillated by the oscillator 2 and that received signal and outputs a frequency difference signal showing the frequency difference between the transmission signal and the received signal (a signal, in a baseband band, whose frequency is acquired by downconverting the frequency of the received signal) to the ADC 7 (step ST4).

When receiving the frequency difference signal from the mixer 6, the ADC 7 performs slide sampling on the in-phase component and the quadrature-phase component of the frequency difference signal (step ST5).

In this case, the slide sampling is a process of sampling the frequency difference signals outputted from the mixer 6 at intervals of a period a little longer than the transmission period P set by the controller 1.

Although the example of performing the slide sampling on the reflected pulses (the received signals) before their frequencies are downconverted by the mixer 6 is shown in FIG. 3, also when performing the slide sampling on the frequency difference signals after their frequencies are downconverted by the mixer 6, the slide sampling is carried out in the same way.

For example, when 100.1 ns (= 1/9.99 MHz) is set as the sampling period (the period a little longer than the transmission period P), sampling is performed on the frequency difference signals outputted from the mixer 6 at intervals of the sampling period of 100.1 ns.

Period of 100.1 ns=100 ns (transmission period P)+0.1 ns

In this case, because the transmission period P of the transmission pulses is 100 ns, the sampling period for the frequency difference signals is 100.1 ns, and the difference between both the periods is 0.1 ns, the sampling point for each frequency difference signal is made to slide by 0.1 ns. In FIG. 3, an example in which the sampling point for each reflected pulse is made to slide by 0.1 ns in a rightward direction in the figure is shown.

Therefore, when the distance counter 8, which will be described below, combines a plurality of sampling data which are acquired by sliding the sampling point by 0.1 ns, as shown in FIG. 3, into combined data, the combined data are equivalent to sampling data which are acquired by sampling the frequency difference signals at intervals equal to a high frequency of 1/0.1 ns (=10 GHz).

After performing the slide sampling on the frequency difference signals outputted from the mixer 6, the ADC 7 performs the process of classifying the sampling data about each of the frequency difference signals according to the range bins (R₀, R₁, R₂, . . . ) based on the distance resolution corresponding to the pulse width set by the controller 1 (step ST6).

Because the process of classifying the sampling data according to the range bins (R₀, R₁, R₂, . . . ) can be carried out on the basis of a time which has elapsed until the reception antenna 5 receives a reflected pulse since a corresponding transmission pulse has been emitted from the transmission antenna 4, but the process of classifying the sampling data according to the range bins is a known technique, the detailed explanation of the process will be omitted hereafter.

For example, when the range bin of the sampling data is R0, the ADC 7 outputs the sampling data to the memory of the distance counter 8 which corresponds to the range bin R0, whereas when the range bin of the sampling data is R1, the ADC outputs the sampling data to the memory of the distance counter 8 which corresponds to the range bin R1.

The distance counter 8 is provided with the memory corresponding to each of the range bins (R₀, R₁, R₂, . . . ), and combines a plurality of sampling data belonging to each identical range bin to generate combined data as shown in FIG. 3 by, every time when sampling data is outputted from the ADC 7, storing the sampling data in the memory corresponding to the corresponding range bin (step ST7).

As a result, combined data corresponding to sampling data which are acquired at intervals equal to a high frequency of (1/0.1 ns) are held in the memory corresponding to each of the range bins (R₀, R₁, R₂, . . . ).

The selection switch 9 is connected to a memory, among the memories respectively corresponding to the range bins (R₀, R₁, R₂, . . . ) of the distance counter 8, which is indicated by the controller 1, and outputs the combined data of the plurality of sampling data stored in that memory to the speed discrimination unit 10.

For example, the combined data of each of the range bins are outputted to the speed discrimination unit 10 in the order of the range bins R0→R1→R2→ . . . .

The speed discrimination unit 10 is provided with the plurality of filters having different frequency characteristics (e.g., an HPF (high pass filter) having a frequency characteristic of e^{-j(2πfdH)t}, an LPF (low pass filter) having a frequency characteristic of e^{-j(2πfdL)t}, and so on).

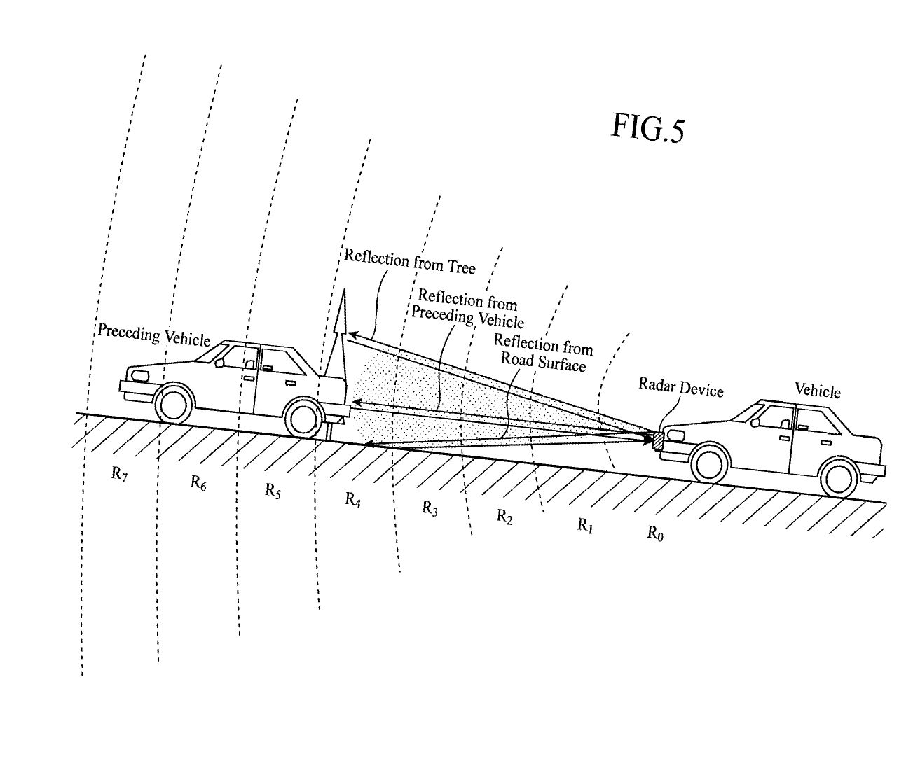

FIG. 5 is an explanatory drawing showing a state in which the radar device detects a preceding vehicle.

In the example of FIG. 5, a tree, a road surface, etc., in addition to a preceding vehicle, exist at the range bin R₄ in the measurement direction of the radar device (e.g., ahead of the vehicle).

Therefore, the combined data of the range bin R₄ include not only data associated with a reflected pulse from the preceding vehicle, but also data associated with reflected pulses from the tree and the road surface.

At that time, the relative speed f_{d3} of the preceding vehicle relative to the vehicle, the relative speed f_{d1} of the tree relative to the vehicle, and the relative speed f_{d2} of the road surface relative to the vehicle differ from one another, and the relative speed f_{d3} of the preceding vehicle is low as compared with the relative speed f_{d1} of the tree and the relative speed f_{d2} of the road surface.

f_{d1}>f_{d2}>f_{d3}

Thus, in order to be ready for an environment in which a tree, a road surface, etc. exist in addition to a preceding vehicle, the speed discrimination unit 10 is provided with at least a filter having a frequency characteristic of e^{-j(2πfd3)t} which corresponds to the relative speed f_{d3} of the preceding vehicle, a filter having a frequency characteristic of e^{-j(2πfd1)t} which corresponds to the relative speed f_{d1} of the tree, and a filter having a frequency characteristic of e^{-j(2πfd2)t} which corresponds to the relative speed f_{d2} of the road surface.

When receiving the combined data of either one of the range bins from the selection switch 9, the speed discrimination unit 10 separates the combined data according to relative speeds of objects by causing the combined data to pass through the plurality of filters (step ST8).

In the example of FIG. 5, data Rx3 associated with the reflected pulse from the preceding vehicle are acquired from the filter having a frequency characteristic of e^{-j(2πfd3)t} corresponding to the relative speed f_{d3} of the preceding vehicle as combined data after being separated.

Further, data Rx1 associated with the reflected pulse from the tree are acquired from the filter having a frequency characteristic of e^{-j(2πfd1)t} corresponding to the relative speed f_{d1} of the tree, as combined data after being separated, and data Rx3 associated with the reflected pulse from the road surface are acquired from the filter having a frequency characteristic of e^{-j(2πfd2)t} corresponding to the relative speed f_{d2} of the road surface, as combined data after being separated.

No combined data after being separated are outputted from any filters other than these filters. For example, from a filter having a frequency characteristic corresponding to the relative speed of an opposite vehicle which does not exist at the range bin R₄, no data associated with a reflected pulse from the opposite vehicle is acquired.

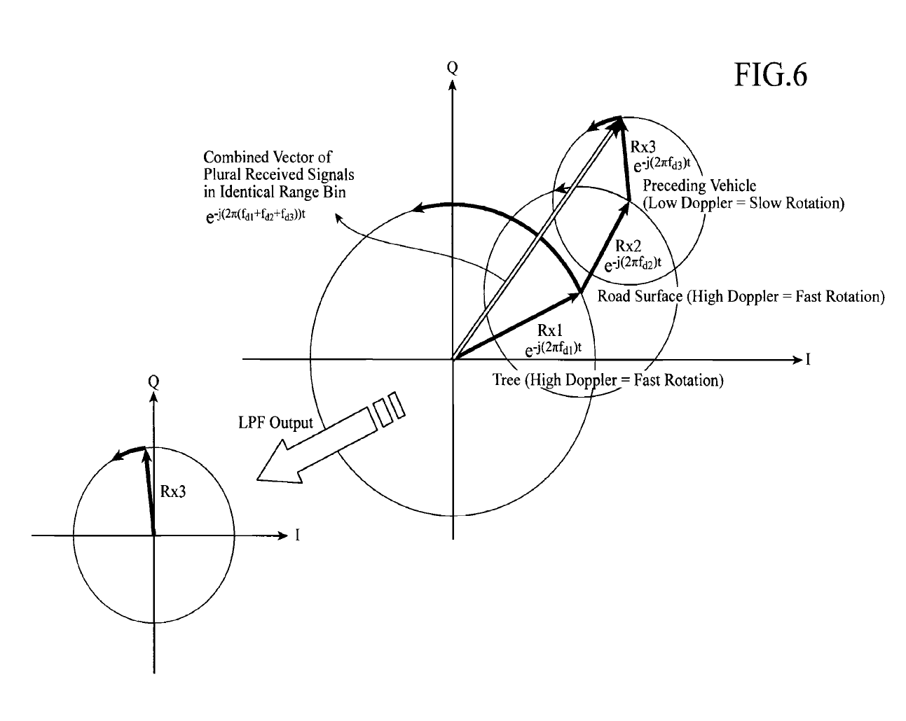

FIG. 6 is an explanatory drawing showing a state in which the data Rx3 about the preceding vehicle is separated from the combined data of the range bin R₄ at which a preceding vehicle, a tree and a road surface exist.

Because when a preceding vehicle, a tree and a road surface exist at the identical range bin R₄, as shown in FIG. 5, a reflected pulse from the preceding vehicle, a reflected pulse from the tree, and a reflected pulse from the road surface are mixed and received, a combined vector of e^{-j(2π(fd1-fd2+fd3))t} which is a combination of the data Rx1, Rx2 and Rx3 associated with these reflected pulses is acquired as combined data of the range bin R₄, as shown in FIG. 6.

Because when the combined data of the range bin R₄ are inputted to the filter having a frequency characteristic of e^{-j(2πfd3)t} corresponding to the relative speed f_{d3} of the preceding vehicle, the data Rx2 and Rx3 associated with the reflected pulses are removed by that filter, only the data Rx1 associated with the reflected pulse is outputted from that filter.

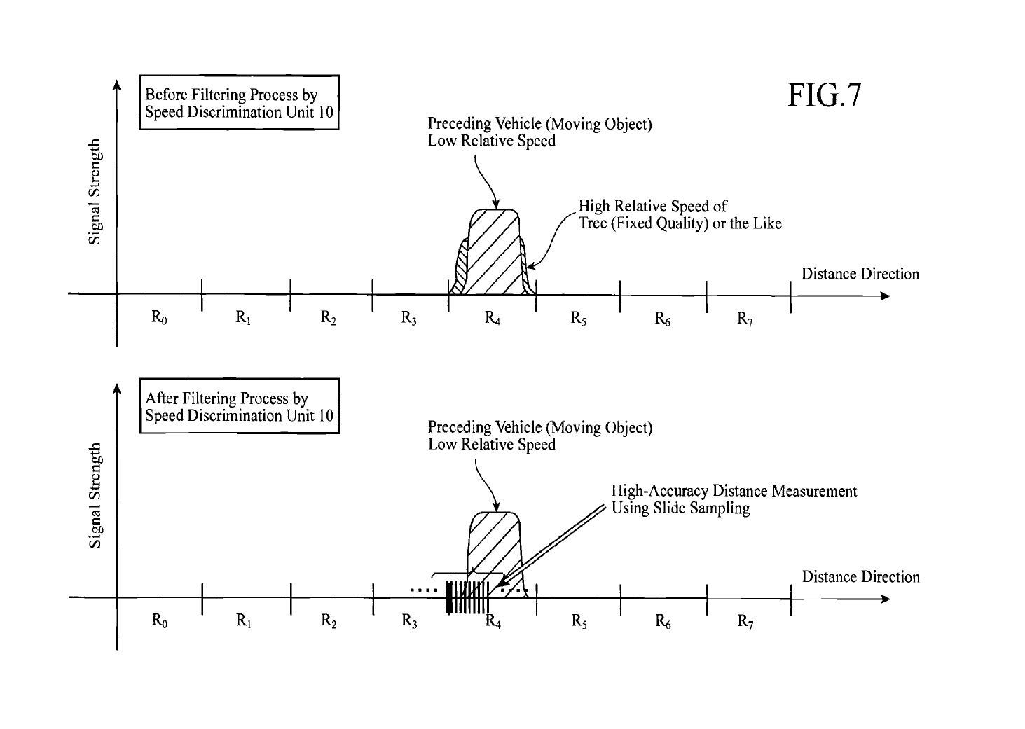

FIG. 7 is an explanatory drawing showing the difference between the signal strength before the filtering process by the speed discrimination unit 10, and the signal strength after the filtering process.

In the example of FIG. 7, a state in which when the combined data of the range bin R₄ are inputted to the filter having a frequency characteristic of e^{-j(2πfd3)t} corresponding to the relative speed f_{d3} of the preceding vehicle, the data other than the data Rx1 associated with the reflected pulse from the preceding vehicle are removed and only the data Rx1 associated with the reflected pulse from the preceding vehicle is acquired with a high degree of accuracy is shown.

The distance and speed measurement unit 11 calculates the distance R to and the relative speed V of each object existing at each of the range bins (R₀, R₁, R₂, . . . ) by using the combined data after being separated according to relative speeds by the speed discrimination unit 10 (step ST9).

Because a preceding vehicle, a tree and a road surface exist at the range bin R₄ in the example of FIG. 5, the distance and speed measurement unit calculates the distance R to and the relative speed V of the preceding vehicle from the data Rx3 outputted from the filter having a frequency characteristic of e^{-j(2πfd3)t} corresponding to the relative speed f_{d3} of the preceding vehicle, and calculates the distance R to and the relative speed V of the tree from the data Rx1 outputted from the filter having a frequency characteristic of e^{-j(2πfd1)t} corresponding to the relative speed f_{d1} of the tree.

The distance and speed measurement unit also calculates the distance R to and the relative speed V of the road surface from the filter having a frequency characteristic of e^{-j(2πfd2)t} corresponding to the relative speed f_{d2} of the road surface.

Hereafter, the process of calculating the distance R to and the relative speed of an object will be explained concretely.

For example, when receiving the data Rx3 from the filter having a frequency characteristic of e^{-j(2πfd3)t} corresponding to the relative speed f_{d3} of the preceding vehicle, the distance and speed measurement unit 11 determines the delay time T_{d} which has elapsed until a transmission pulse reflected by the preceding vehicle and then returns thereto since the transmission pulse has been emitted from the transmission antenna 4 by determining the pulse rising position of the data Rx3.

For example, when the pulse rising position of the data Rx3 is the 200-th sampling point in the slide sampling, the delay time T_{d} is 20 ns in the case in which the sampling point is made to slide by 0.1 ns, as mentioned above.

Delay time T_{d}=200×0.1 ns=20 ns

After determining the delay time T_{d}, the distance and speed measurement unit 11 calculates the distance R from the vehicle to the preceding vehicle by substituting the delay time T_{d} into the following equation (1).

$$R = \frac{{CT}_{d}}{2} \qquad ( 1 )$$

In the equation (1), C denotes the radio wave propagation speed (=3.0×10⁸ m/sec).

Therefore, when the delay time T_{d} is 20 ns, 3 m is calculated as the distance R from the vehicle to the preceding vehicle.

For example, when calculating the relative speed V of the preceding vehicle, the distance and speed measurement unit 11 determines the amount θ of change (rad) of the phase rotation per unit time Tₛ of reflected pulses (=100 μsec=1000 samples×100 ns (= 1/10 MHz)).

Because the data Rx3 outputted from the filter having a frequency characteristic of e^{-j(2πfd3)t} corresponding to the relative speed f_{d3} of the preceding vehicle has an in-phase component and a quadrature-phase component, the distance and speed measurement unit can determine the amount θ of change of the phase rotation per unit time Tₛ from a change in the direction of the vector which consists of the in-phase component and the quadrature-phase component.

After determining the amount θ of change of phase rotation, the distance and speed measurement unit 11 calculates the relative speed V between the vehicle and the preceding vehicle by substituting the amount θ of change of phase rotation into the following equation (2).

$$V = \frac{λ}{2} \times \frac{θ}{2 π} \times \frac{1}{Ts} \qquad ( 2 )$$

In the equation (2), lambda denotes the wavelength of the radio wave whose frequency is 24 GHz (e.g., 12.4 mm).

Therefore, when the amount θ of change of phase rotation is, for example, 30 degrees (=π/6 (rad)), 5.17 mm/msec=18.6 km/hour is calculated as the relative speed V of the preceding vehicle.

As can be seen from the above description, because the radar device according to this Embodiment 1 is configured in such a way that the radar device includes the ADC 7 that performs the slide sampling on the in-phase component and the quadrature-phase component of each frequency difference signal outputted from the mixer 6, and classifies the sampling data about the frequency difference signal according to range bins based on the distance resolution corresponding to the pulse width W set by the controller 1, and the speed discrimination unit 10 that separates the sampling data of each range bin after being classified by the ADC 7 according to relative speeds of objects, and the distance and speed measurement unit 11 calculates the distance R to and the relative speed V of each object by using the sampling data after being separated according to relative speeds by the speed discrimination unit 10, there is provided an advantage of being able to calculate the distance R to and the relative speed V of each object with a high degree of accuracy even under an environment in which it is difficult to ensure a wide occupied bandwidth (an environment in which it is difficult to narrow the pulse width W of transmission pulses and shorten the transmission period P of transmission pulses).

Further, because the distance counter 8 according to this Embodiment 1 is provided with a memory corresponding to each of the range bins (R₀, R₁, R₂, . . . ), and is configured in such a way as to combine a plurality of sampling data belonging to each identical range bin to generate combined data by, every time when sampling data is outputted from the ADC 7, storing the sampling data in the memory corresponding to the corresponding range bin, the combined data equivalent to sampling data acquired at intervals equal to a high frequency of (1/0.1 ns) can be provided for the speed discrimination unit 10. As a result, there is provided an advantage of being able to improve the accuracy of the calculation of the distance R to and the relative speed V of each object even if the sampling period is low.

Further, because the speed discrimination unit 10 according to this Embodiment 1 is provided with a plurality of filters having different frequency characteristics, and is configured in such a way as to separate the combined data outputted from the selection switch 9 according to relative speeds of objects by causing the combined data to pass through the plurality of filters, there is provided an advantage of being able to calculate the distance R to and the relative speed V of each of a plurality of objects existing at an identical range bin even in a situation in which a wide occupied bandwidth cannot be ensured and hence the distance resolution becomes low, and reflected pulses from the plurality of objects at the identical range bin are received.

While the invention has been described in its preferred embodiment, it is to be understood that various changes can be made in an arbitrary component according to the embodiment, and an arbitrary component according to the embodiment can be omitted within the scope of the invention.

### INDUSTRIAL APPLICABILITY

The radar device and the distance and speed measurement method according to the present invention classify sampling data about a frequency difference signal between each reflected pulse and transmission pulses according to range bins, separates sampling data about each range bin according to relative speeds of objects, and calculates the distance to and the relative speed of each object by using the sampling data after being separated according to relative speeds. As a result, because the distance to and the relative speed of each object can be calculated with a high degree of accuracy even under an environment in which it is difficult to ensure a wide occupied bandwidth, the radar device and the distance and speed measurement method are suitable for detecting a preceding vehicle etc. on a road environment.

### EXPLANATIONS OF REFERENCE NUMERALS

1 controller (pulse setter), 2 oscillator (pulse transmitter), 3 pulse modulator (pulse transmitter), 4 transmission antenna (pulse transmitter), 5 reception antenna (pulse receiver), 6 mixer (pulse receiver), 7 ADC (sampler), 8 distance counter (sampler), 9 selection switch (sampler), 10 speed discrimination unit (signal separator), and 11 distance and speed measurement unit (distance and speed calculator).

1. A radar device comprising:
a pulse setter to set a pulse width and a transmission period of transmission pulses;
a pulse transmitter to generate transmission pulses each having the pulse width set by said pulse setter, and repeatedly emit said transmission pulses into space at intervals of the transmission period set by said pulse setter;
a pulse receiver to receive, as reflected pulses, transmission pulses which are included in the transmission pulses emitted from said pulse transmitter and each of which is reflected by an object and then returns thereto, and output frequency difference signals respectively showing frequency differences between said reflected pulses and the transmission pulses emitted from said pulse transmitter;
a sampler to sample the frequency difference signals outputted from said pulse receiver at intervals of a period longer than the transmission period set by said pulse setter, combine a plurality of sampling results to generate sampling data about said frequency difference signals, and classify the sampling data about said frequency difference signals according to range bins based on a distance resolution corresponding to the pulse width set by said pulse setter;
a signal separator to separate sampling data about each of the range bins after being classified by said sampler according to relative speeds of objects; and
a distance and speed calculator to calculate a distance to and a relative speed of the object which has reflected said transmission pulse by using sampling data after being separated according to relative speeds by said signal separator.

2. (canceled)

3. The radar device according to claim 1, wherein said signal separator includes a plurality of filters having different frequency characteristics, and causes the sampling data about each of the range bins after being classified by said sampler to pass through said plurality of filters to separate said sampling data according to relative speeds of objects.

4. The radar device according to claim 1, wherein said distance and speed calculator characterizes an amount of change of a phase rotation of the sampling data after being separated according to relative speeds by said signal separator, and calculates the relative speed of said object from the amount of change of said phase rotation.

5. The radar device according to claim 1, wherein said pulse transmitter performs pulse modulation on a radio wave having a frequency in a 24 GHz band to generate the transmission pulses each having the pulse width set by said pulse setter.

6. A distance and speed measurement method comprising the steps of:
in a pulse setter, performing a pulse setting process of setting a pulse width and a transmission period of transmission pulses;
in a pulse transmitter, performing a pulse transmitting process of generating transmission pulses each having the pulse width set in said pulse setting process step, and repeatedly emitting said transmission pulses into space at intervals of the transmission period set in said pulse setting process step;
in a pulse receiver, performing a pulse receiving process of receiving, as reflected pulses, transmission pulses which are included in the transmission pulses emitted in said pulse transmitting process step and each of which is reflected by an object and then returns thereto, and outputting frequency difference signals respectively showing frequency differences between said reflected pulses and the transmission pulses emitted in said pulse transmitting process step;
in a sampler, performing a sampling process of sampling the frequency difference signals outputted in said pulse receiving process step at intervals of a period longer than the transmission period set by said pulse setting process step, combining a plurality of sampling results to generate sampling data about said frequency difference signals, and classifying the sampling data about said frequency difference signals according to range bins based on a distance resolution corresponding to the pulse width set in said pulse setting process step;
in a signal separator, performing a signal separating process of separating sampling data about each of the range bins after being classified in said sampling process step according to relative speeds of objects; and
in a distance and speed calculator, performing a distance and speed calculating process of calculating a distance to and a relative speed of the object which has reflected said transmission pulse by using sampling data after being separated according to relative speeds in said signal separating process step.
